(19) United States
(12) Patent Application Publication
(10) Pub. No.: US 2015/0058149 A1
(43) Pub. Date: Feb. 26, 2015

(54) NON-INTERNET BASED NETWORKED ELECTRONIC COMMUNICATION AND TRANSMISSION SYSTEM FOR CONDUCTING AUCTIONS

(71) Applicant: Michael J Radcliffe, Elka Park, NY (US)

(72) Inventor: Michael J Radcliffe, Elka Park, NY (US)

(21) Appl. No.: 14/010,496

(22) Filed: Aug. 26, 2013

(51) Int. Cl. G06Q 30/08

(52) U.S. Cl. CPC G06Q 30/08
USPC 705/26.3

(57) ABSTRACT

A non-Internet-dependent networked communication and transmission system and method for conducting one or more auctions via an electronic interface connecting an auctioneer at a master computer or server and one or more bidders at enticement locations, with software to control the auction process.

### CLAIM OF PRIORITY

This application claims priority to Provisional application for U.S. Patent No. 61/694,249 filed Aug. 29, 2012, and to Provisional application for U.S. Patent No. 61/834,423 filed on Jun. 13, 2013, which are incorporated herein by reference for all purposes.

### THE FIELD OF INVENTION

A method utilizing an electronic communication and transmission system that is networked relating to conducting and participating in a bidding fee auction.

### DEFINITIONS

An auction is a process of buying and selling cash, goods, or services by offering them up for bid, taking bids, and then selling the item to the highest bidder.

A bidding fee auction, also called a penny auction, is a type of all-pay auction in which all participants must pay a non-refundable fee to place each small incremental bid. The auction ends after a period of time, ranging from seconds to minutes or longer in the absence of new bids. The last participant to have placed a bid wins the item and also pays the final bid price, which may be significantly lower than the retail price of the item. The auctioneer can make money in at least two ways: the fees for each bid from all the bidders and the payment for the winning bid, the sum of which can total more than the value of the item. A bidding free auction is a type of auction. All bidding fee auctions are auctions but not all auctions are bidding fee auctions.

Bidder, also a participant, is a person who bids on an item.

Enticement Location(s), also known as Enticement Screen(s) are viewing screens and/or other viewing devices and/or other audiovisual devices that also are connected to the network and are set-up in various locations (at least one location) for potential participants and/or bidders to view the current auctions in progress through the networked communication and transmission network.

auctioneer or operator, is the person (or persons, collectively referred to as the “auctioneer”) who runs the auction (host of the auction, i.e.: Casino) via the master computer and/or server and/or hub.

Auction timer determines the time duration for which each auction will be active and bidders can continue to bid on an item or items. The auctioneer presets the auction timer to a specific time, and the auction timer decrements as the auction proceeds.

Bidding fee auction timer determines the time duration for which each bidding fee auction will be active and bidders can continue to bid on an item or items. The auctioneer presets the bidding fee auction timer to a specific time, and the bidding fee auction timer decrements as the bidding fee auction proceeds. Time may be added to the bidding fee auction timer as bidder(s) bid. A bidding fee auction timer can be an auction timer but an auction timer might not be a bidding fee auction timer. Both the auction timer and/or bidding fee auction timer may simply be referred to as a timer.

Non-Internet dependent electronic interface, is a communications interface that can comprise a keyboard, keypad, touch screen, or other data input device that is not internet dependent and does not necessarily rely on or connect to what is commonly referred to as the internet backbone. This could be any private intranet, wire linked internal network, isolated fiber optic network, and/or wireless communications system.

### SUMMARY OF THE INVENTION

In the present embodiment the invention comprises a networked communication and transmission system and method for conducting at least one auction by means of a non-Internet dependent electronic interface, which comprises a master computer and/or server and/or other electronic hub 1, controlled by an auctioneer, that controls one or more auctions, at least one enticement location for at least one bidder to participate in the bidding process, and the software to control the auction process. The auction can be at least one bidding fee auction. The operator of the master computer and/or server or other hub 1 who controls the auction process is known as the auctioneer. The enticement location contains a viewing screen or enticement screen 2, and this viewing or enticement screen 2 displays images and information related to the auction in progress and the item 20 for which bidders are bidding on. These images and information are of a nature to aid bidders in the bidding process, and the images and information includes graphs and graphic representations of information. There can be more than one simultaneous auction in progress and more than one item 20 for which bidders are bidding on. The software enables communication between the master computer and/or server and/or hub 1 and the various enticement locations, and there can also be communication between one enticement location and another. There is an auction timer 23 which displays the time remaining in the auction, and this auction timer can be a bidding fee auction timer. This bidding fee auction timer 23 can determine the time duration for which each auction will be active and bidders can continue to bid on an item 20.

The software enables the master computer and/or server and/or hub 1 to designate 100 an item available for an auction and/or a bidding fee auction. The software also has the ability to schedule 101 one or more auctions and/or bidding fee auctions. An auction process conducts at least one auction to completion by performing operations including receiving one or more bids 105 and 107 on the auctioned item 20 from one or more bidders, initializing 106 the auction timer to a predetermined time for each bid received, and terminating 109 the auction after a predetermined time has timed out. A bidding fee auction process conducts at least one bidding fee auction to completion by performing operations including receiving one or more bids 105 and 107 on the bidding fee auctioned item from one or more bidders, initializing 106 the bidding fee auction timer to a predetermined time for each bid received, and terminating 109 the bidding fee auction after the predetermined time has timed out. A bidder in a bidding fee auction can submit up to as many bids as he has purchased. The enticement screen 2 receives information from the master computer and/or server and/or hub 1 and further includes subjective descriptive information, comprising an image of the item 22, the Manufacturer's Suggested Retail Price and/or the Recommended Retail Price 21. The system method is set so the received input related to scheduling 101 a bidding fee auction relates to the time and/or timing of the submission of a bid by a bidder. The images on an enticement screen 2 can include advertising for one or more things that can be bought before, during, or after an auction. One auction can influence other auctions according to static rules and/or dynamic rules set by the auctioneer.

Further, a bidder can utilize the electronic interface in order to view, enter, and participate in a bidding fee auction via process 220. Bidders can purchase bids 203 from the auctioneer or operator prior to entering into a bidding fee auction. After purchasing bids from the auctioneer, the bidder may enter any of the available bidding fee auctions by submitting a single bid 204 in that auction, and the bidder can enter as many auctions as there are simultaneously running Once the first bidder has entered a single bid, the bidding fee auction can begin and the bidding fee auction timer 23, whose time denomination is set by the auctioneer, can begin to count down to zero from this pre-set time. Once a bidder has submitted a single bid 204, the bidder may, but is not required to, enter more bids 207. Each bid entered by a bidder adds additional time to the bidding fee auction timer 23, and this time is determined by the auctioneer. When the bidding fee auction timer times out or reaches zero, the bidding fee auction can be deemed to be over 209. If a bidder submitted the final bid in the bidding fee auction and the bidding fee auction timer has reached zero, that bidder can be deemed to have won 210 and is considered to have purchased the auction prize for the amount of the final offer. If the RUNNER-UP (also known as second place, but still a losing bid) did not submit the final bid in the bidding fee auction, and the bidding fee auction timer had reached zero 209, the hosting establishment may offer that bidder the option 211 to purchase the item from the bidding fee auction at a price predetermined by the auctioneer. Second place bidders or any other bidders can be awarded handicaps or inducements 212 for other auctions, including but not limited to credit card points and/or cash to get things later. An entire game theory can be established to engage in serially sequenced auctions as well as simultaneously occurring auctions.

### Implementation and Use Process

In its present embodiment the invention can be used in a variety of venues including but not limited to casinos, airports, airplanes, cruise ships, lounges, bars, arcades, malls, horse and car race tracks, stores, homes, etc.

The invention can comprise implementing a “Penny Auction” type game into an electronic mechanism that allows for use in venues such as but not limited to a casino.

A perspective player or bidder can walk along a casino gaming floor and, upon seeing a huge monitor which displays several items soon to be or currently being auctioned, can enter the auction at one of the many enticement locations.

The invention includes the ability to have a legal form of gambling via non-internet networked electronic transmission that can be implemented within a gaming environment.

This invention brings the “auction” format into various venues and types of establishments, which includes but is not limited to casinos, airports, airplanes, cruise ships, lounges, bars, arcades, malls, horse and car race tracks, stores, homes, etc.

Enticement locations can be individual freestanding units, kiosks, virtual tables, and/or devices added to existing machines and/or other locations throughout an establishment. The acceptance of currency can be set as any other existing casino machine, i.e. wager, player card, etc.

The invention can incorporate but is not limited to a portable, mobile, fixed or stationary device that delivers the necessary auction display and controls necessary to engage people in the auction process from within the establishment.

### BRIEF DESCRIPTION OF THE DRAWINGS

FIG. 1 shows a system block diagram and element relationship for a typical bidding fee auction process from the operator's or auctioneer's side of the process.

FIG. 2 shows a system block diagram and element relationship for a typical bidding fee auction process from the participant's or bidder's side of the process.

FIG. 3 shows a sequence of steps for a bidder to participate in an auction.

FIG. 4 shows a sequence of steps for an auctioneer to run an auction.

FIG. 5 shows a typical screen shot of a bid in progress where the item being bid on is a $1000 bundle of cash.

### DETAILED DESCRIPTION OF THE DRAWINGS

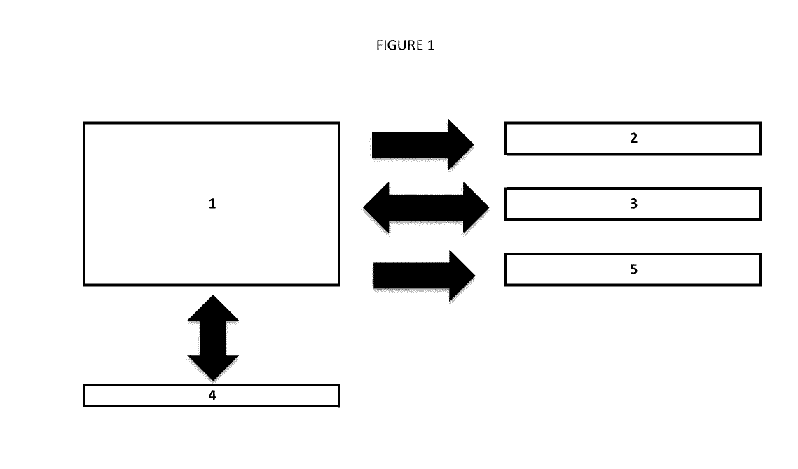

In FIG. 1, which shows a system block diagram and element relationship for a typical bidding fee auction process from the operator's or auctioneer's side of the process, the server 1 has bidirectional communication between the bidder's input device 3 and other input devices 4. The server 1 communicates with the bidder's enticement screen 2 that is associated with that bidder's input device 3. Many other input devices 4 can have bidirectional communication with the server 1, and many enticement screens 5 can be located throughout the venue.

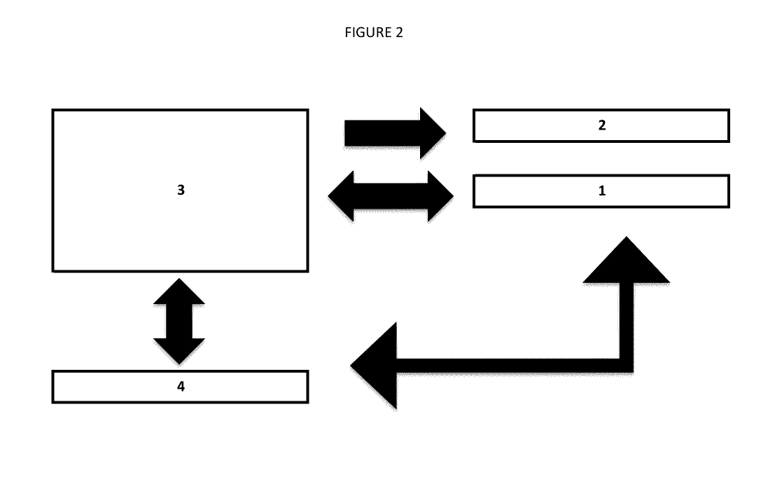

In FIG. 2, which shows a system block diagram and element relationship for a typical bidding fee auction process from the participant's or bidder's side of the process, the bidder's input device 3 has bidirectional communication between the server 1 and other input devices 4. The bidder's input device 3 can communicate with his enticement screen 2, and the server 1 can also communicate with the bidder's enticement screen 2 as well and other input devices 4.

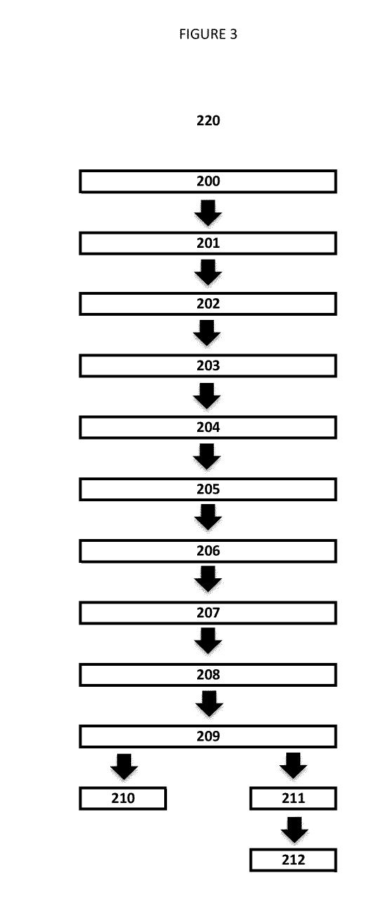

FIG. 3 shows a sequence of steps for a bidder process 220 to participate in an auction whereby the bidder is viewing an enticement screen 2 at an enticement location.

In step 200, the bidder views the enticement screen 2.

In step 201 the bidder determines what item 20 to bid on.

In step 202 the bidder enters identifying data such as room card or number, location rewards card, credit card or number, credit card, cash, or other customer specific identifying information.

In step 203 the bidder purchases one or more bid packages from auctioneer.

In step 204 the bidder submits a bid for one item 20 or more items.

In step 205 the bidding fee auction timer time 23 appears on the enticement screen 2 and begins to count down from a preset time.

In step 206, as the auction progresses, the latest high bid current price 24 appears on each bidder's viewing screen 2 and/or 5.

In step 207 the bidder can submit more bids, though this is optional.

In step 208, with each bid submitted, more time is added to bidding fee auction timer.

In step 209, if bidding fee auction timer reaches 0 and/or times out the auction ends and one of two things can happen:

either the bidder wins 210, or the bidder looses in step 211. If he is a runner-up he may have the option to purchase the same item being auctioned for a preset price.

In step 212, the second place bidder and/or other losing bidders may be offered handicaps or inducements including but not limited to cash for other auctions.

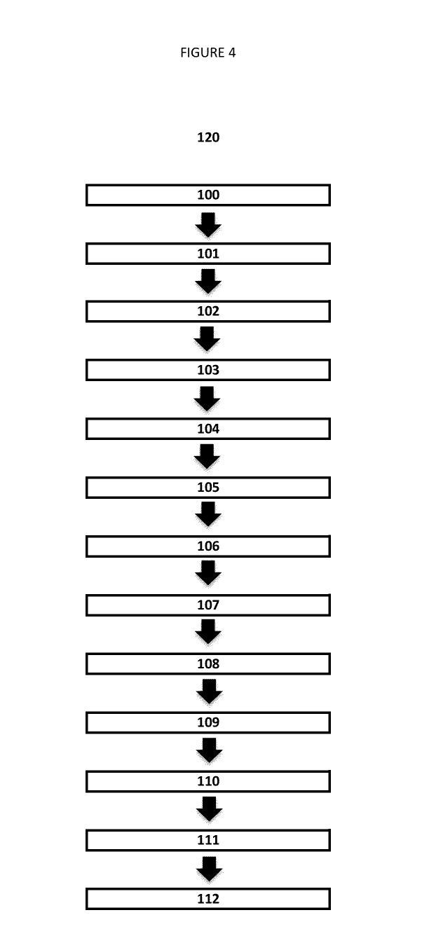

FIG. 4 shows a sequence of steps for an auctioneer at master computer and/or server or hub 1 to run 120 an auction.

In step 100 the auctioneer designates and describes an item 20 or items for auction on a bidder's enticement screen 2 and/or on multiple enticement screens 5.

In step 101, the auctioneer sends auction scheduling information out to enticement screens 5.

In step 102 the auctioneer receives the bidder's identifying data.

In step 103 the auctioneer matches this to an existing account or he creates a new account.

In step 104 the auctioneer receives and accepts a bid package or bit packages from a bidder.

In step 105 the auctioneer receives a bid or bids from a bidder for one or more items.

In step 106 the auctioneer initializes the bidding fee auction timer for a bidder after the bidder joins the auction.

In step 107 the auction is in progress and the auctioneer receives one or more bids on the auctioned item from one or more bidders.

In step 108 the auction is progressing and the auctioneer sends updates of latest high bid current price 24 to all enticement locations 5.

In step 109, the auctioneer terminates the auction after the predetermined time has timed out or alternatively, at such time as he may wish to extend extra time depending on auction activity.

In step 110 the auctioneer communicates with the winning bidder.

In step 111, the auctioneer communicates with all losing bidders informing all as to their respective status in that auction. This includes communication with the runner-up or runners-up, who may be offered the opportunity to purchase the same or similar items for a preset price.

In step 112 the auctioneer offers handicaps and other inducements including but not limited to cash for future auctions and/or items for sale.

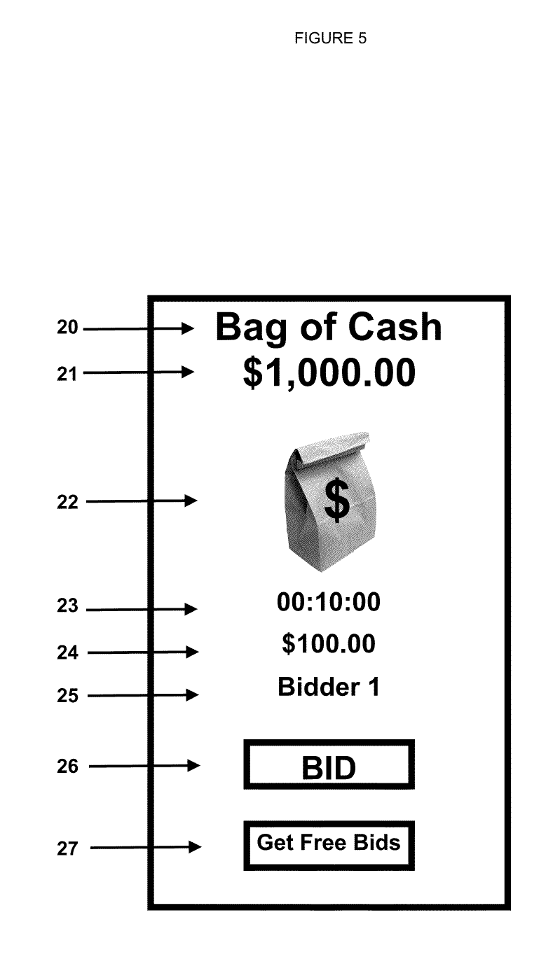

FIG. 5 displays a screen shot of a typical enticement screen 2 of a bid in progress where the item 20 being bid on is a $1000 bundle of cash. It could just as easily be any item. The product price or market value 21 is shown, and below that is an image 22 of item 20. Below that is the bidding fee auction timer 23, which decrements as the auction proceeds. The current price 24 is shown, and this value grows as bidders bid up the price they are willing to pay for the item 20 being bid on. The last bidder to bid 25 is displayed, and the “place bid” button 26 enables the bidder to submit a bid. At the bottom is a button for: Like or share, get free bids 27.

### Method Flow and Through Process

The Method Flow and Through Process of this invention comprises a networked communication and transmission system method for conducting bidding fee auctions by means of a non-Internet dependent, electronic interface, comprising of a networked communication and transmission system that runs software programmed to offer a bidding fee action process through a networked operator or auctioneer's master computer and/or server and/or hub 1 that runs the bidding fee auction software, communicating with multiple networked electronic interfaces which communicate with the main or master computer and/or server and/or hub 1 and with each other, and various enticement locations, and each enticement location can have a viewing screen 2 which is also connected to the network. Enticement locations are places where potential participant bidders can view the current auction or auctions in progress. The auctioneer's master computer and/or server and/or hub 1, as well as each of the electronic interfaces at each respective enticement location, together, are collectively programmed to run and utilize their allotted components of the bidding fee auction software. The auctioneer's master computer and/or server and/or hub 1 transmits and/or broadcasts images 22 and information of available items for the bidding fee auction to the electronic interface of the enticement screen(s) 5 at the enticement locations via a non-internet based communication network, and data is input from any of the electronic interfaces and received over the communication and transmission network. Information from the auctioneer's master computer and/or server and/or hub and/or terminal or other data input, transmission, and receiving device 1, can correspond to an item 20 up for bid in the bidding fee auction, which includes:
(i) a designation of an item 20 available for auction, and
(ii) information relating to scheduling participation in an auction for the item, based at least in part or whole on the designation of an item 20 available in the bidding fee auction.

The information relating to scheduling a bidding fee auction for the item previously received from the networked auctioneer's master computer and/or server and/or hub 1 automatically initiates a bidding fee auction and the process of the bidding fee auction for the item 20. This process enables communication to a network of interconnected participant or bidder computers, connected via a communication network, wherein the automatically initiated bidding fee auction process conducts the bidding fee auction to completion by performing operations including:

Receiving one 104 or more bids 105 on the bidding fee auctioned item 20 from one or more bidders;

Increasing the bidding fee auction timer to a predetermined time for each bid received 208; and

terminating 109 the auction after the predetermined time has timed out or reached zero. The networked communication and transmission system method can have the input relating to the scheduling of an auction for the item as an invocation of the auction process at the networked auctioneer's master computer and/or server and/or hub 1. The auctioneer can have physical possession of the item 20 for auction and is authorized to sell such item for auction. The bidder can submit up to as many bids as the bidder has purchased. The information received from auctioneer's master computer and/or server and/or hub can further include subjective descriptive information, comprising, an image 22 of the item, the Manufacturer's Suggested Retail Price and/or the Recommended Retail Price 21. The networked communication and transmission system method can be set so the received input related to scheduling a bidding fee auction relates to the timing of the submission 204 of a bid by participant.

The Method Flow and Through Process of this invention can comprise of the following steps:
202 Submitting/entering/swiping bidder's Identifying Data, such as bidder's Room Card/Number, Location, Reward Card/Number, Credit Card, or submitting a certain denomination of currency;
103 Master computer and/or server and/or hub 1 will either match any or all of the above to an existing account or create a new user account and user profile;
203 Purchasing a Bid Package;
204 Submitting a single bid towards the Bidding Fee Auction of bidder's choosing in order to join bidding fee auction;

A bidder may enter as many bids as the bidder has purchased;

The bidder has the option to purchase the bidding fee auction item 20 at a discounted price in the event that bidder did not submit the final bid before the bidding fee auction timer timed out, and the establishment may offer that bidder the option to purchase the item from the bidding fee auction at a price predetermined by the auctioneer.
106 As each bidder joins the auction the auctioneer initializes the bidding fee auction timer 23 to a predetermined time for that bidder.
107 The auctioneer can receives one or more bids on the auctioned item 20 from one or more bidders
108 As an auction progresses, the auctioneer updates the latest high bid current price 24 on each bidder's viewing screen 2 at his enticement location.
109 The auctioneer terminates the auction after the predetermined time has timed out.
110 Then auctioneer communicates with the winning bidder and informs him as to how to collect his prize.
111 The auctioneer communicates with all losing bidders, informing them as to their respective status in that auction.
112 The auctioneer can then offer handicaps and other inducements for future auctions and/or items for sale.

The auction items can include but are not limited to electronics, jewelry, crystal, vacations, air fares, cash, luggage, gift cards, scholarships for kids, tuition, a percentage to charity as added inducements, green energy credits for solar conversion, sports events tickets or discounts, cars, and gifts and/or gifts given away with celebrity endorsements to winners, to name a few.

Auction items can also include satchels of cash, with different satchels being different denomination.

### SAMPLE EXAMPLES

One embodiment of networked communication and transmission system method for a localized bidding fee auction can be described by way of the following examples, with reference to the drawings:

Assume the following for this example:

$1000 in cash is being auctioned, so this is the real value because it is money. It could just as easily be any item 20 with an equivalent monetary value, like a watch or anything else with a suggested retail price of $1000. This is a “penny auction” and, if desired, a bidder can increment his bid by any amount but as little as one penny. The cost to place a single bid is one dollar, and the cost of a bid can be any amount decided upon by the auctioneer. For this example assume the bidding begins at zero and the first bid is one penny. If 500 people are collectively bidding from 500 individual locations, and each bidder makes 11 bids each, incrementing the previous bid by only a penny, then 500 bidders×11 bids/bidder=5500 total bids being made. Each bid costs the bidder one dollar, so 5500 bids produces $5500 for the house. 5500 bids×$0.01/bid (to increment from previous value) means the price would be bid up to $55.00. So the winner has placed 11 bids costing him $11, but he has just won $1000, or he is ahead by $1000−$11, and his net profit is $989.

Item Real Value=$1000 (displayed as 20 in FIG. 5)

500 bidders×11 bids/bidder=5500 total bids

5500 Bids×$1.00/bid=$5500.

5500 bids×1 penny/bid=$55.00=winning value item sold for (displayed as 24 in FIG. 5).

Net profit to house=$1000−$55+$5500=$4445

Net profit to winner=$1000−$11=$989.

There will clearly be a more advanced game theory at work as real people hedge and bid as close to the actual value of the item as they can, and margins fall, but the overall result will still be a net positive for the house. Obviously if a person makes ten bids and wins $1000 for $990 he has made nothing. But if a thousand bids were made to produce this result, the house would also make $990.

Also contemplated is use of the invention in venues at sea or on water, and even under water, and underground, and allows for the entity or business operating auctions to link and synch between multiple establishments that may or may not be under the same or similar ownership. The establishments that can use the invention include but are not limited to hotels, airports, malls, horse or car race tracks, and/or any betting institute, and can also occur in flight. This method could be expanded to connect to any public or private communication network for communication between participants and/or perspective bidders and/or bidders and the establishment outside the venue in a variety of locations that include but are not limited to the participant's or bidder's home and/or office. Establishments that offer complimentary points to guests can offer to exchange or redeem same for bids and/or offer bids directly in place of comp points or any combination thereof.

While the instant invention has been shown and described in accordance with preferred and practical embodiments thereof, it is recognized that departures from the instant disclosure are contemplated within the spirit and scope of the present invention. Therefore, the true scope of the invention should not be limited since other modifications will become apparent to those skilled in the art upon study of the drawings, claims, description, and specification herein.

What is claimed:

1. A networked communication and transmission system and method for conducting at least one auction by means of a non-Internet dependent electronic interface, comprising of:
at least one of a master computer, server, and/or hub that controls at least one auction;
at least one enticement location and/or non-Internet dependant electric interface for at least one bidder to participate in at least one bidding process; and
software to run and/or operate and/or control at least one of the system and/or auction process.

2. The networked communication and transmission system and method for conducting at least one auction by means of a non-Internet dependent electronic interface of claim 1, wherein said at least one auction is at least one bidding fee auction.

3. The networked communication and transmission system and method for conducting at least one auction by means of a non-Internet dependent electronic interface of claim 1, wherein an operator or auctioneer is the person(s) who runs the auction via said at least one of a master computer, server, and/or hub.

4. The networked communication and transmission system and method for conducting at least one auction by means of a non-Internet dependent electronic interface of claim 1, wherein said at least one enticement location contains at least one viewing screen.

5. The networked communication and transmission system and method for conducting at least one auction by means of a non-Internet dependent electronic interface of claim 4, wherein said viewing screen displays images and information related to at least one auction in progress and the item(s) for which bidder(s) are bidding on.

6. The networked communication and transmission system and method for conducting at least one auction by means of a non-Internet dependent electronic interface of claim 5, wherein said viewing screen displayed images and information are of a nature to aid bidder(s) in the bidding process.

7. The networked communication and transmission system and method for conducting at least one auction by means of a non-Internet dependent electronic interface of claim 6, wherein said viewing screen displayed images and information includes graphs and/or graphic representations of said information.

8. The networked communication and transmission system and method for conducting at least one auction by means of a non-Internet dependent electronic interface of claim 1, wherein there are more than one simultaneous said at least one auction and more than one item for which bidder(s) are bidding on.

9. The networked communication and transmission system and method for conducting at least one auction by means of a non-Internet dependent electronic interface of claim 1, wherein said software enables communication between said at least one of a master computer, server, and/or hub and said at least one enticement location and/or between one of said at least one enticement location and another of said at least one enticement location.

10. The networked communication and transmission system and method for conducting at least one auction by means of a non-Internet dependent electronic interface of claim 1, further comprising an auction timer(s) or bidding fee auction timer(s) which will determine the time duration for which said at least one auction will be active and said bidder(s) can continue to bid on an item(s).

11. The networked communication and transmission system and method for conducting at least one auction by means of a non-Internet dependent electronic interface of claim 1, wherein said software enables said at least one of a master computer, server, and/or hub to designate at least one item available for at least one auction.

12. The networked communication and transmission system and method for conducting at least one auction by means of a non-Internet dependent electronic interface of claim 1, wherein said software has the ability to schedule said at least one auction.

13. The networked communication and transmission system and method for conducting at least one auction by means of a non-Internet dependent electronic interface of claim 2, wherein said software has the ability to schedule at least one bidding fee auction.

14. The networked communication and transmission system and method for conducting at least one auction by means of a non-Internet dependent electronic interface of claim 13, wherein said at least one bidding fee auction influences other said at least one bidding fee auction according to static rules and/or dynamic rules set by the auctioneer.

15. The networked communication and transmission system and method for conducting at least one auction by means of a non-Internet dependent electronic interface of claim 2, wherein said at least one enticement screen receives information from the said at least one of a master computer, server, and/or hub and further includes subjective descriptive information, comprising of at least one of an image of the item, the Manufacturer's Suggested Retail Price and/or the Recommended Retail Price.

16. The networked communication and transmission system and method for conducting at least one auction by means of a non-Internet dependent electronic interface of claim 2, wherein the system method is set so the received input related to scheduling said at least one bidding fee auction relates to the time and/or timing of the submission of a bid(s) by a bidder(s).

17. The networked communication and transmission system and method for conducting at least one auction by means of a non-Internet dependent electronic interface of claim 7 wherein said images includes advertising for one or more things that can be purchased before, during, or after an auction(s).

18. The networked communication and transmission system and method for conducting at least one auction by means of a non-Internet dependent electronic interface of claim 13, wherein the bidder of said at least one bidding fee auction can submit up to as many bids as the bidder has purchased.

19. The networked communication and transmission system and method for conducting at least one auction by means of a non-Internet dependent electronic interface of claim 1, is further expanded to utilize a non-Internet based network connection to any public or private communication network for communication between bidder(s) and an establishment outside of the venue in which the auctioneer is located, and this includes a variety of locations that is but is not limited to at least one of the bidder's home or office, ships at sea, airplanes, airports, hotels, malls, horse or car race tracks, and/or any betting institute.

20. A Method of conducting a non-internet dependant auction comprising the following steps:
a) submitting/entering/swiping his/her Identifying Data, such as his/her Room Card/Number, Location, Reward Card/Number, Credit Card, and/or submitting a certain denomination of currency;
b) matching submission in a) above to an existing account or creating a new user account and user profile;
c) purchasing a Bid Package;
d) submitting a single bid towards the Bidding Fee Auction of bidder's choosing in order to join bidding fee auction;
e) initializing said auction timer or bidding fee auction timer to a predetermined time for each bid received;
f) entering as many bids as bidder has purchased;
g) either purchasing the auction or bidding fee auction item at a discounted price in the event that bidder did not submit the final bid before the auction or bidding fee auction timer times out, and further, the establishment may offer that bidder the option to purchase the item from the auction or bidding fee auction at a price predetermined by the auctioneer;
h) initializing the auction or bidding fee auction timer to a predetermined time for each bidder as that bidder joins the auction;
i) auctioneer receives one or more bids on the auctioned item from one or more bidders;
j) as auction progresses, the updated latest high bid appears on each bidder's viewing screen at each respective bidder's enticement location;
k) termination of the auction after the predetermined time has timed out;
l) auctioneer communicating with all bidders, including the winner, informing all as to their respective status in that auction;
m) auctioneer offers handicaps and other inducements for future auctions and/or items for sale.
